(19) United States
(12) Patent Application Publication
(10) Pub. No.: US 2014/0289848 A1
(43) Pub. Date: Sep. 25, 2014

(54) METHOD FOR CLASSIFYING PACKING ALGORITHMS USING ENTROPY ANALYSIS

(71) Applicant: Korea University Research and Business Foundation, Seoul (KR)

(72) Inventors: Heejo Lee, Seoul (KR); Munkhbayar Bat-Erdene, Seoul (KR); Hyuncheol Jeong, Seoul (KR); Daegull Ryu, Seoul (KR)

(73) Assignee: Korea University Research and Business Foundation, Seoul (KR)

(21) Appl. No.: 14/224,474

(22) Filed: Mar. 25, 2014

Related U.S. Application Data
(60) Provisional application No. 61/804,844, filed on Mar. 25, 2013.

(51) Int. Cl. G06F 21/50

(52) U.S. Cl. CPC G06F 21/50
USPC 726/22

(57) ABSTRACT

A method for classifying packed executable is provided. The method includes unpacking an input packed executable by using a decompression module included in the packed executable; calculating an entropy value of a memory space on which decompressed code is mounted in the unpacking step; converting the entropy value into symbolic representations; and classifying packing algorithms of the packed executables based on the entropy value converted into symbolic representations. The step of classifying includes inputting the entropy value converted into symbolic representations to a packing classifier which classifies packing algorithms of the packed executables based on similarity between a pattern of the packing classifier and the data converted into the symbolic representations.

### CROSS-REFERENCE TO RELATED APPLICATION

This application claims the benefit of U.S. Provisional Patent Application No. 61/804,844 filed on Mar. 25, 2013, the disclosures of which are incorporated herein by reference.

### TECHNICAL FIELD

The embodiments described herein pertain generally to a method for classifying packing algorithms using entropy analysis.

### BACKGROUND

Various types of malwares destroy the security system of user computers and collects users' personal information. As a result, there is the occasion where a significant amount of financial loss occurs. Negative attackers use various techniques to make detection of such malwares difficult. One of the techniques that they are using is executable compression or packed executable.

Packing algorithm was developed to compress a size of files in the publicly known manners such as zip and rar using compression and encryption algorithms, or protect computer programs from copying program through reverse engineering. However, the packing algorithm compresses executables, and not data. When the packing technique is used, a file size of malwares becomes smaller, and thus, the propagation velocity of the malwares is faster. Further, the original code is transformed, thereby, making analysis of the malwares more difficult. For easy detection of the packed executable, there have been many researches on an unpacking technique.

The previous researches on the unpacking technique are briefly reviewed.

For detection and classification of packed executable, there is known a method using a pattern recognition technique. This method uses publicly available unpacking tools and a signature based anti-malware system to distinguish between malwares and benign executable codes. In the method, it is identified whether an executable is in the compressed state; if the executable is in the compressed state, it is decompressed, and then, hidden files are detected; and the hidden files are transmitted to a virus detection module. If the executable is not in the compressed state, the executable is transmitted to the virus detection module. However, this method cannot decompress the packed executable that is not publicly known.

Example embodiments described herein provide a method for identifying and classifying packing algorithms.

### SUMMARY

In view of the foregoing, example embodiments provide a packed executable classification method, which can identify and classify packing algorithms, no matter whether the packing algorithm is already known or not.

In accordance with an example embodiment, a method for classifying packed executable is provided. The method includes unpacking an input packed file by using a decompression module included in the packed executable; calculating an entropy value of a memory space on which decompressed code is mounted in the unpacking step; converting the entropy value into symbolic representations; and classifying packing algorithms of the packed executables based on the entropy value converted into symbolic representations. The step of classifying includes inputting the entropy value converted into symbolic representations to a packing classifier which classifies packing algorithms of the packed executables based on similarity between a pattern of the packing classifier and the data converted into the symbolic representations.

In accordance with the example embodiments, since entropy analysis is utilized for classification of packed executables, the classification can also be implemented for packing algorithms that is not already known. Furthermore, as time series data calculated upon the entropy analysis are converted into symbolic representations, a calculation amount required for data learning can be significantly reduced.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a packing classification device in accordance with an example embodiment;

FIG. 2 shows a structural change of a packed file in accordance with an example embodiment;

FIG. 3 illustrates symbolic aggregate approximate (SAX) time series representations in accordance with an example embodiment;

FIG. 4 illustrates a symbolic conversion algorithm in accordance with an example embodiment; and

FIG. 5 is a flow chart showing a method for classifying packing algorithms in accordance with an example embodiment.

### DETAILED DESCRIPTION

Hereinafter, example embodiments will be described in detail with reference to the accompanying drawings so that inventive concept may be readily implemented by those skilled in the art. However, it is to be noted that the present disclosure is not limited to the example embodiments but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. In addition, the term “comprises or includes” and/or “comprising or including” used in the document means that one or more other components, steps, operations, and/or the existence or addition of elements are not excluded in addition to the described components, steps, operations and/or elements.

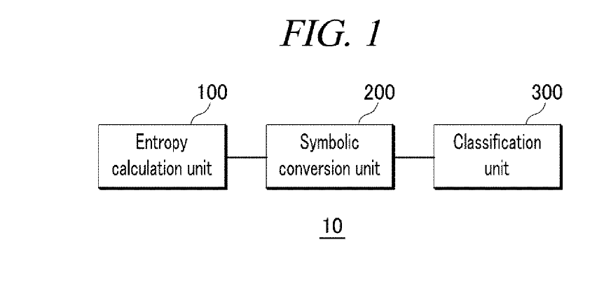

FIG. 1 illustrates a packing classification device in accordance with an example embodiment.

A packing classification device 10 includes an entropy calculation unit 100, a symbolic representation unit 200, and a classification unit 300.

For reference, the components illustrated in FIG. 1 in accordance with an example embodiment may imply software or hardware such as a field programmable gate array (FPGA) or an application specific integrated circuit (ASIC), and carry out predetermined functions.

However, the “components” are not limited to the software or the hardware, and each of the components may be stored in an addressable storage medium or may be configured to implement one or more processors.

Accordingly, the components may include, for example, software, object-oriented software, classes, tasks, processes, functions, attributes, procedures, sub-routines, segments of program codes, drivers, firmware, micro codes, circuits, data, database, data structures, tables, arrays, variables and the like.

The components and functions thereof can be combined with each other or can be divided.

The entropy calculation unit 100 calculates entropy of a packed file in the process of executing the file to be unpacked. Korean Patent Application Publication No. 10-2011-0100508 (Title of Invention: Unpacking Device Using Entropy Analysis and Method thereof), which was filed by the inventor of the present disclosure, describes an entropy analysis method with respect to packing, the description of which is referenced herein.

As the entropy calculation unit 100 executes the file to be unpacked to implement the unpacking, the file to be unpacked undergoes an internal change and exhibits an entropy change. For understanding of this process, it is necessary to study the structure of the packed file.

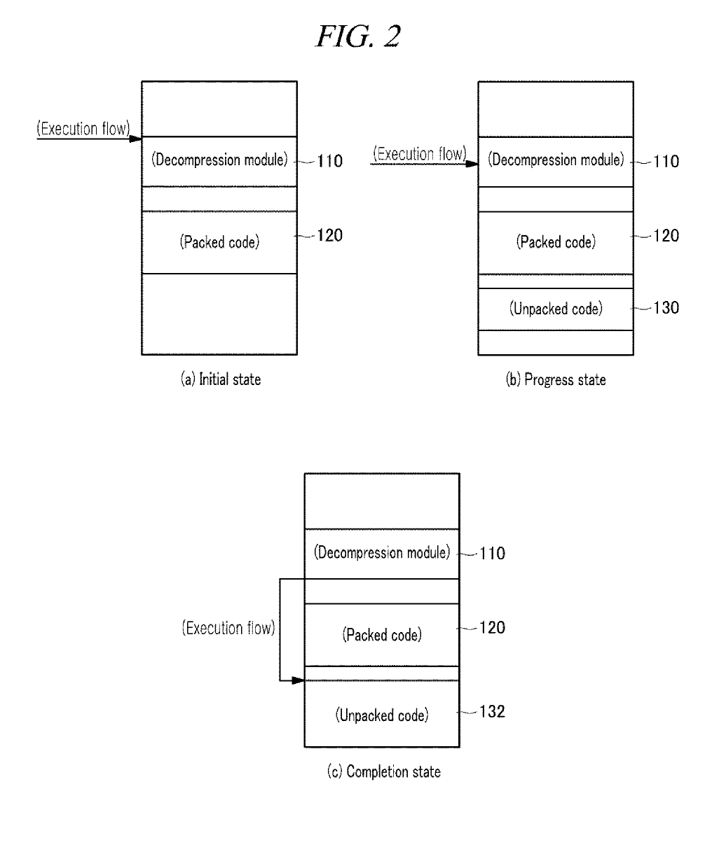

FIG. 2 shows a structural change of a packed file in accordance with an example embodiment.

As illustrated in FIG. 2, the packed file in the initial state includes a decompression module 110 and a compressed code 120. The compressed code 120 corresponds to a data portion stored after an original executable is compressed by a packing program, and the decompression module 110 is generated by the packing program and used to restore the original executable. In other words, if the original executable is compressed by executing the packing program, the compressed code 120 and the decompression module 110 are generated. As representative packing programs, there are UPX, ASPack, FSG, Telock, PECompact, WWPack32, EZip, Pex, JDPack, DoomPack, Mew and so on.

Unpacking starts with execution of the decompression module 110. As the unpacking is implemented, a decompressed code 130 is written in a memory space. In this case, the decompressed code 130 is written in a different space from the memory space where the compressed code 120 exists, and this is controlled by the decompression module 110. When the execution flow reaches the end of the decompression module 110, all codes 132 decompressed from the compressed code 120 are written in the memory space, and the unpacking process is completed. At this time, the execution flow that has reached the end of the decompression module 110 jumps to the first part of the decompressed codes 132, rather than to the compressed code 120, and this part is called an original entry point.

The entropy calculation unit 100 detects branch instructions among instructions executed while the packing process is implemented. Once a program is executed, processes are implemented in the unit of instructions for writing address values in a consecutive order, storing data in a corresponding address value, or other purposes. Accordingly, writing new branch statement or inserting execution statement is also implemented in the unit of instructions. An entropy value also needs to be measured based on the unit of instructions with respect to a target process. However, measuring an entropy value each time instructions are executed would be inefficient. Thus, a device for distinguishing executable instructions is necessary.

In setting criteria for distinguishing executable instructions, it is necessary to remember the unpacking process. Since an original entry point address is eventually called after the branch instruction statement according to the execution flow, it is desirable to distinguish whether or not branch instructions are detected. For example, an entropy value is measured when branch instructions such as JMP or CALL are detected.

The detected branch instructions perform the important role of determining the time point for entropy detection. However, since the branch instructions are mostly executed at repeated loops or branch points, they delay the unpacking. To resolve this problem, a cache memory may be used.

A speed of a hard disk is significantly slower than a RAM. The slow speed is attributed to the circumstance that the disk should be read each time a program is executed. Accordingly, a temporary memory with a certain capacity is provided between a RAM and a disk such that contents loaded into the RAM when a program is initially executed are also stored in the temporary memory. Thereafter, when the program is executed, the contents from the temporary memory, and not the hard disk, are read so that the reading time is shortened. The temporary memory is called a cache memory.

If n branch instructions that have been most recently executed are stored in the cache memory, the execution speed in repeated call loops is faster, and thus, the speed of determining the original entry point is also faster.

The entropy calculation unit 100 calculates an entropy value of a memory space on which unpacked file is mounted when branch instructions are detected. That is, the time point that the branch instructions are detected corresponds to the time point for calculating the entropy value. Entropy is generally one of state functions of the thermodynamic system and indicates statistical disorder. However, Shannon indicated an amount of information with numerals through the concept of “Information Entropy” to establish information entropy H with the following Math Formula 1:

$$H ( x ) = {\sum }_{i = 1}^{n} p ( {x}_{i} ) I ( {x}_{i} ) = - {\sum }_{i = 1}^{n} p ( {x}_{i} ) {log}_{b} p ( {x}_{i} ) \qquad [ Math Formula 1 ]$$

Where p(xi) is the probability of occurrence of xi, and I means self-information of a discrete probability variable X. As representative examples for the base number b of the logarithm, there are 2, Euler's number e, and 10. In general, entropy in the information theory is commonly used in researching the field relating to message compression. As data have high entropy, it means that all bits, which possibly appear, uniformly exist. Thus, as an entropy value of a particular compressed file is high, the compression rate is high. For example, there is a string code of “100100100111111.” If the string code is in a 3-bit unit, it can be compressed by arranging the number of the consecutive strings and the consecutive strings in this order. The above-mentioned string code can be compressed to “011100010111” because the string code consists of 3 (011) consecutive codes 100 and 2 (010) consecutive codes 111. Entropy of the above-mentioned code and the compressed code is calculated according to Math Formula 1 assuming that the base number b of the logarithm is 2. As a result, the entropy value of the compressed code “011100010111” is approximately 1.5, which is greater than the entropy value of approximately 1.0306 for the code “100100100111111” before the compression.

If the target for the calculation of an entropy value is set to the entire virtual memory space, the degree of entropy change is insignificant, and thus, it would be difficult to analyze changes of the entropy.

Accordingly, analysis of entropy changes may be set to be conducted for a specific memory space. For example, analysis of entropy changes may be set to be conducted through a fixed memory space. Since the position where the original code is written corresponds to the first section of the packing process, the first section of the packing process may be set as the target memory space. This is because the entropy value for the portion where the original code is not newly written while the unpacking is implemented will not change even though it is calculated. If the fixed memory space is set as the target for the entropy calculation, it is advantageous in that writing measurement algorithms is convenient, and execution routes are simple, requiring less execution time. However, depending on packing programs, there may be the occasion that the original code is not written in the first section of the packing process. In this case, there is a high possibility that the original entry point cannot be determined or is erroneously determined. Moreover, the fixed space as described above has limit in detection of rapidly evolving malwares.

As another method, analysis of entropy changes may be set to be conducted based on a memory space on which unpacked file is mounted. The memory space on which unpacked file is mounted is a variable space, and not a fixed space, and can be dynamically determined when the original code is written while the unpacking process is implemented. At the level of machine language instructions, the work for reading and writing in a memory consists of a combination of instructions for storing an address value of a memory in a resistor and instructions for moving data to the stored address value. Accordingly, by using the combination of the instructions, an address of a memory space on which unpacked file is mounted can be identified. As an example for the instructions for storing an address value of a memory in a resistor, there are LEA instructions. As an example for moving data to the stored address value, there are MOV instructions.

If entropy analysis is conducted for the variable space, and not the fixed space, a measurement value excluding dummy data can be obtained. Furthermore, as the entropy analysis space is clearly specified, changes of the entropy also become clear so that the original entry point detection probability increases. Since the original data will be necessarily written throughout the unpacking process, no matter what packing programs are, it is possible to analyze packed files by a compression program, which will be developed in the future, as well as all existing packing programs.

Meanwhile, the entropy calculation unit 100 stores the calculated entropy value in a storage medium. An entropy value is calculated each time branch instructions are detected, and may be accumulatively stored. The accumulated entropy value is used to determine the original entry point or decide whether or not the unpacking process is completed.

The entropy calculation unit 100 determines the original entry point by using changes of the calculated entropy value. Since a packed file has a higher entropy value than a common executable file, an entropy value of the corresponding process memory increases at the initial unpacking stage due to the packed code. However, the entropy value of the memory becomes constantly stable throughout the unpacking process. However, when the entropy analysis is conducted for a memory part of a specific space, if another code having high entropy exists in the portion where the decompressed code is written, the entropy value may gradually increases to become constantly stable.

In either case, entropy is constantly converged while the unpacking process is completed. The time point that the calculated entropy value begins to be constantly converged corresponds to the time point that the unpacking process is completed. The address, to which the execution flow moves after the completion, corresponds to the original entry point.

By comparing the calculated entropy value with a pre-defined entropy minimum value (Emin) and a pre-defined entropy maximum value (Emax), it can be determined whether or not the unpacking is completed. If the calculated entropy value is between the pre-defined entropy minimum value and the pre-defined entropy maximum value, it can be determined that the unpacking has been completed. The entropy minimum and maximum values may be set from a multiple number of converged entropy sample values obtained from unpacking files packed by various types of packing programs in consideration of errors.

Returning to FIG. 1, the symbolic conversion unit 200 converts the entropy value calculated through the entropy calculation unit 100 into symbolic representations. Since the entropy data calculated through the entropy calculation unit 100 are time series data, which have high-dimensionality and continuity, a calculation amount in a learning process for classification of time series data is increased.

In order to resolve this problem, for example, a time series representation method such as symbolic aggregate approximation (SAX) for efficient and effective processing of time series data may be used. SAX combines segmentation and discretization techniques to convert consecutive time series data to be in the discrete form in a low dimensional space. Such SAX uses the piecewise aggregate approximation (PAA) segmentation technique to reduce the dimensionality of the time series.

PAA decides an average of the time series data belonging to the respective segments as a PAA coefficient value. PAA represents the time series data by using the PAA coefficient values. The discretization of SAX divides the entire area by the Gaussian distribution curve into equal-sized areas under the normality assumption to determine discretization areas. The PAA coefficient values located in the respective discretization areas are discretized.

To be more specific, according to the PAA segmentation, n-dimensional time series data T are converted into M-dimensional vectors, in which n>>M. That is, n-dimensional time series data T are divided into M segments in an n/M size. The time series values located in the respective segments are averaged to calculate a coefficient for each of the segments. The calculated coefficient has a value of Math Formula 2.

$$\overline{{x}_{i}} = \frac{1}{r} [ {\sum }_{j = r ( i - 1 ) + 1}^{ri} ( {x}_{i} ) ] \qquad [ Math Formula 2 ]$$

where r=n/M, and x refers to each segment.

The calculated coefficient is converted into an integer vector or a symbol sequence.

Through this process, entropy time series data can be converted into symbolic representations.

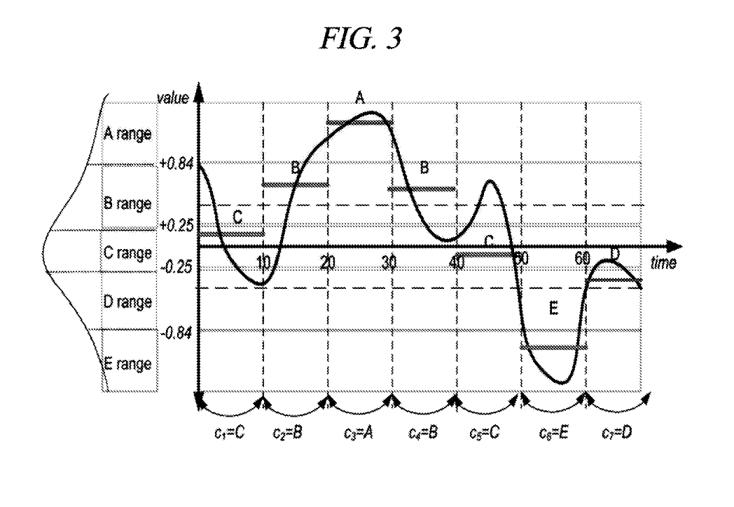

FIG. 3 illustrates SAX time series representations in accordance with an example embodiment.

FIG. 3 assumed that the number of the segments is 7, and the number of discretization is 5, and symbolized the entire time series data into five types of symbols (A, B, C, D, E). As the entire time series data are converted into symbolic representations, the calculation amount required for data learning can be reduced.

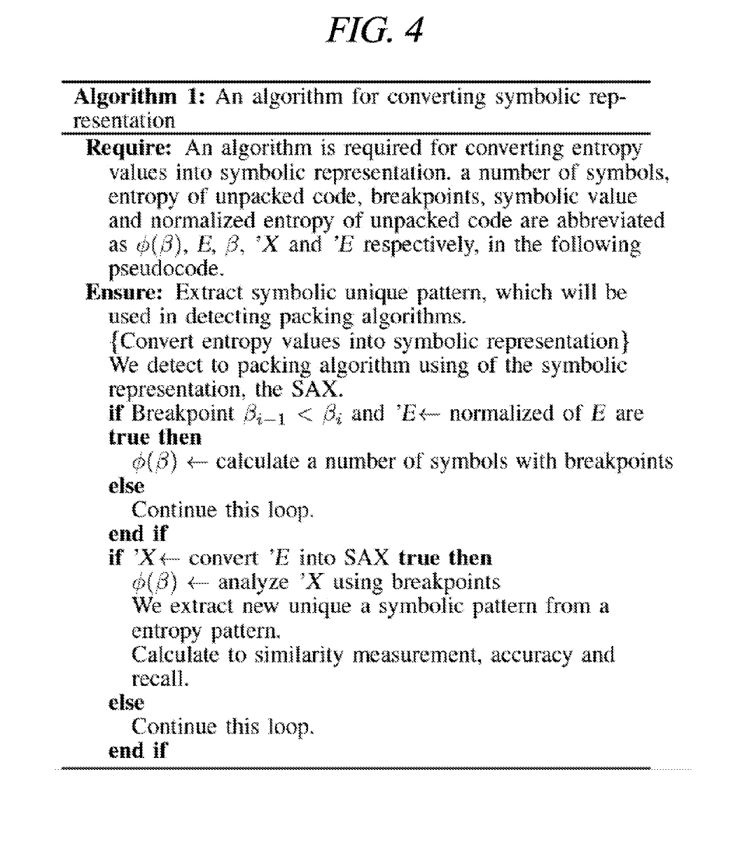

FIG. 4 illustrates symbolic conversion algorithm in accordance with an example embodiment.

As depicted in FIG. 4, symbolic conversion for entropy time series data is implemented.

As a result of the symbolic conversion, the following effects are achieved.

First, the dimensionality of the entropy data is reduced. PAA algorithm is a technique for conversion into lower dimensionality, which is often used in analyzing time series data. The PAA algorithm divides time series data into several zones, and then, calculates an average value of the zones, to convert high-dimensional time series data into low-dimensional time series data.

Second, the lowest limit of the entropy data can be set. The lowest limit means a boundary value, which is smaller than or the same as all values of given entropy data sets. Setting the lowest limit provides a criterion for measurement of a distance for the original entropy data before the conversion into symbolic representations. Accordingly, the distance between two different symbolic strings can be demonstrated only from verification of the PAA representation technique itself.

Third, breakpoints can be set. Since normalized SAX entropy data have high normal distribution, one can easily determine the breakpoints that produce equally sized areas under the normal distribution curve.

Fourth, the Euclidean distance for the symbolic converted data as well can be calculated like Math Formula 3, through which similarity of data and others can be identified.

$$ɛ DS ( \overline{Q} , \overline{S} ) = \sqrt{\frac{n}{N}} \sqrt{{\sum }_{i = 1}^{M} {( {\overline{Q}}_{i} - {\overline{S}}_{i} )}^{2}} \qquad [ Math Formula 3 ]$$

where Q̅ and S̅ refer to data converted into symbolic representations.

Returning to FIG. 1, the classification unit 300 classifies packed executable by using the symbolic-converted entropy data. That is, the classification unit 300 classifies packing algorithms, by which corresponding packing is produced. The operation of the classification unit 300 is described with reference to the drawings.

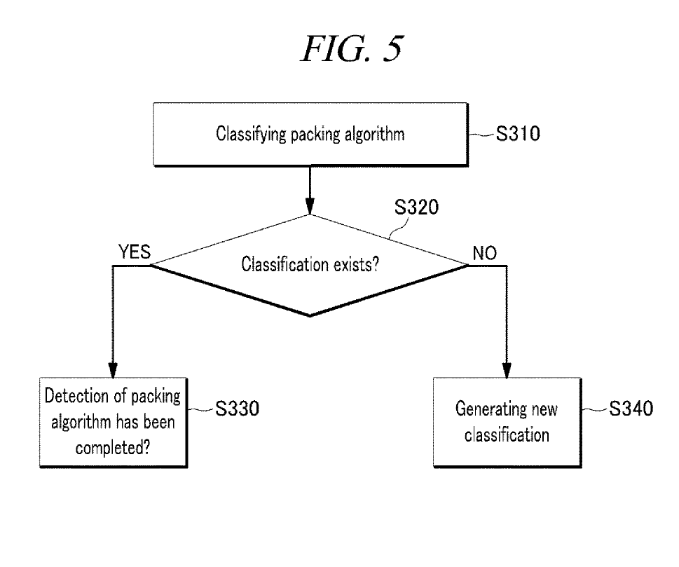

FIG. 5 is a flow chart showing a method for classifying packing algorithms in accordance with an example embodiment.

First, packing algorithm is classified through comparison with previously known packing algorithm (S310). To this end, a classifier for classifying packing should be constructed and may be constructed under a supervised classification technique or an unsupervised classification technique. Further, with respect to learning of the classifier, a Naïve Bayes classification method, a support vector machine (SVM) method, and others may be used, but the present disclosure may not be limited thereto.

Meanwhile, classification of packing algorithm is selected based on similarity between the produced classifier and input packed executable (S320). In this case, the similarity can be calculated by using the following Math Formula 4:

$$Φ ( x , y ) = \frac{{\sum }_{i = 1}^{n} ( {x}_{i} * {y}_{i} )}{[ \sqrt{{\sum }_{i = 1}^{n} {x}_{i}^{2}} \sqrt{{\sum }_{i = 1}^{n} {y}_{i}^{2}} ]} \qquad [ Formula 4 ]$$

where a similarity coefficient (Φ(x,y)) measures the linear relationship between two different symbolic representation data (x, y) and calculates the strength and the direction of the linear relationship. The value is always between −1 and 1, where 1 indicates a strongly positive relation; 0 means no relation; and −1 means a strongly negative relation.

If there is a class where the similarity to input packed executable is a threshold value or more, the packed executable is classified to have been compressed by packing algorithm of the corresponding class (S330).

However, there is no class where the similarity to input packed executable is a threshold value or more, new classification is produced based on the corresponding packing data (S340).

As described, since the example embodiments use the entropy analysis for classifying packing, it can also perform the classification for the packing that was not previously known. Further, by converting the time series data calculated upon the entropy analysis into symbolic representations, a calculation amount required for data learning can be significantly reduced.

The example embodiments can be embodied in a storage medium including instruction codes executable by a computer or processor such as a program module executed by the computer or processor. A computer readable medium can be any usable medium which can be accessed by the computer and includes all volatile/nonvolatile and removable/non-removable media. Further, the computer readable medium may include all computer storage and communication media. The computer storage medium includes all volatile/nonvolatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The method and the system of the example embodiments have been described in relation to the certain examples. However, the components or parts or all the operations of the method and the system may be embodied using a computer system having universally used hardware architecture.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

We claim:

1. A method for classifying packed executable, the method comprising:
unpacking an input packed executable by using a decompression module included in the packed executable;
calculating an entropy value of a memory space on which decompressed code is mounted in the unpacking step;
converting the entropy value into symbolic representations; and
classifying packing algorithms of the packed executables based on the entropy value converted into symbolic representations,
wherein the step of classifying includes inputting the entropy value converted into symbolic representations to a packing classifier which classifies packing algorithms of the packed executables based on similarity between a pattern of the packing classifier and the data converted into the symbolic representations.

2. The method for classifying packed executable of claim 1,
wherein the step of calculating the entropy value includes:
calculating an entropy value of a memory space on which the decompressed code is mounted, when execution of a branch instruction is detected during the step of unpacking; and
regarding an address, to which execution flow moves after the calculated entropy value is converged, as an original entry point.

3. The method for classifying packed executable of claim 1,
wherein the step of converting converts the entropy value, which are consecutive time series data, to be in a discrete form in a reduced dimensional space, based on symbolic aggregate approximation (SAX) algorithm.

4. The method for classifying packed executable of claim 1,
wherein the step of converting includes:
segmenting the entropy value, by applying the piecewise aggregate approximation (PAA) method to the entropy value;
calculating a coefficient for each of the segmented entropy value by averaging time series values located in respective segment of the segmented entropy value; and
symbolizing the coefficients using a plurality of symbols.

5. The method for classifying packed executable of claim 1,
wherein the step of classifying includes:
inputting the data converted into symbolic representations to the packing classifier generated from learning a pattern of a publicly known packing algorithm;
determining whether or not to belong to a class included in the packing classifier based on similarity between the pattern of the packing classifier and the data converted into the symbolic representations; and
generating a new class for the corresponding packing data if the similarity with the class included in the packing classifier is smaller than a threshold value.

6. The method for classifying packed executable of claim 1,
wherein the step of classifying includes:
inputting the data converted into symbolic representations to the packing classifier generated from learning a pattern of a publicly known packing algorithm;
determining whether or not to belong to a class included in the packing classifier based on similarity between the pattern of the packing classifier and the data converted into the symbolic representations; and
classifying the packing algorithm as a class with the highest similarity if there is a class where similarity with a class included in the packing classifier is a threshold value or higher.
